(19) United States
(12) Patent Application Publication
(10) Pub. No.: US 2006/0219487 A1
(43) Pub. Date: Oct. 5, 2006

(54) Wear sensor for brake shoe

(75) Inventors: Manuel Wille, Rankweil (AT); Gunter Jager, Gotzis (AT); Oliver Gachter, Koblach (AT)

Correspondence Address: THE FIRM OF KARL F ROSS, 5676 RIVERDALE AVENUE, PO BOX 900, RIVERDALE (BRONX), NY, 10471-0900, US

(73) Assignee: Hirschmann Automotive GmbH

(21) Appl. No.: 11/364,806

(22) Filed: Feb. 28, 2006

(30) Foreign Application Priority Data
Mar. 1, 2005 (DE) 102005009123.7

(51) Int. Cl. F16D 66/02

(52) U.S. Cl. 188/1.11 L

(57) ABSTRACT

A brake-shoe wear sensor has a sensor element capable of being worn away for generating different electrical outputs in accordance with wear and at least one electrical wire connected to and extending outwardly away from the sensor element so that a controller can be connected to the sensor element via the wire. A one-piece housing has an inner end molded unitarily around and encapsulating the sensor element and an outer end spaced therefrom and molded unitarily around and encapsulating an outer end portion of the wire.

### FIELD OF THE INVENTION

The present invention relates to a sensor. More particularly this invention concerns a wear sensor for a brake shoe.

### BACKGROUND OF THE INVENTION

In order to warn a vehicle owner when the vehicle's brake shoes need replacement, it is known to provide a wear sensor that is connected via the vehicle controller to a warning alarm, e.g. a small lamp. Without this warning, the first indication that a brake shoe was badly worn would be when the composition pad was completely worn off and the shoe's metal backing plate started to dig into the brake disk or drum.

Thus German 198 22 186 proposes a system comprising a pair of feed conductors imbedded in the brake pad and interconnected by a bridge conductor. Once the pad is worn down to a predetermined level, the bridge conductor is worn away and the circuit between the two feed conductors is opened. The controller connected to the sensor can then trigger generation of the alarm.

Adapting this sensor to disk and drum brakes of different vehicles requires a special setup for each and every type of brake pad. What is more, the sensor is only, in effect, an on-off switch so that it does not give the user any information about how much the brake shoe in question is worn, only telling the user that a certain point of wear has been crossed.

Somewhat more sensitive or adaptable systems are shown in U.S. Pat. No. 6,193,029, EP 0,742,380, and DE 101 26 908. While some of these systems do give a range of outputs indicating different wear conditions, and some of them are relatively easily adaptable to different brake shoe conditions, they all are fairly complex and are susceptible to shorting out and such when wet, in particular with water laden with salt in the winter. Installing and connecting up such sensors is laborious and creates junctions and connections that must be sealed meticulously. These sensors are exposed to particularly harsh conditions and have a high rate of failure, leading drivers to think they need new brake shoes when they don not, or failing to inform them of the dangerously worn conditions of their brake shoes.

### OBJECTS OF THE INVENTION

It is therefore an object of the present invention to provide an improved wear sensor for brake shoe.

Another object is the provision of such an improved wear sensor for brake shoe that overcomes the above-given disadvantages, in particular that is of simple construction, that is certain to operate and report accurately under difficult environmental conditions, and that can easily be adapted to different brake shoes.

### SUMMARY OF THE INVENTION

A brake-shoe wear sensor has according to the invention a sensor element capable of being worn away for generating different electrical outputs in accordance with wear and at least one electrical wire connected to and extending outwardly away from the sensor element so that a controller can be connected to the sensor element via the wire. A one-piece housing has an inner end molded unitarily around and encapsulating the sensor element and an outer end spaced therefrom and molded unitarily around and encapsulating an outer end portion of the wire.

The total encapsulation of the sensor element and outer wire end in the housing made of heat-resistant plastic ensures that the sensor can easily be mounted right on the brake shoe. What is more it is easy to adapt a single model of sensor for application to many different types of brake shoes, reducing stocking problems both at the manufacturer and in the repair shop. The same exact sensor element can be used with differently shaped housings adapted for different applications, again reducing production costs since all that needs to be changed is the die in which the housing is molded, the elements around which the housing is molded being identical.

The sensor element is a conductive metallic trace, e.g. a copper foil. It can be part of a printed-circuit board imbedded in the housing. According to the invention the trace has a low-impedance loop and a separate high-impedance loop. One of the loops is spaced more closely to an outer face of the housing outer end than the other of the loops. In addition the high-impedance loop includes a resistor. Such a sensor element is extremely cheap and, as mentioned above, the same element can be used in dozens of differently shaped housings if desired.

The brake-shoe wear sensor further has according to the invention a second such wire connected to and extending outwardly away from the sensor element and encapsulated in the housing. In addition the housing has a formation adapted to fit complementarily with a brake shoe.

### BRIEF DESCRIPTION OF THE DRAWING

The above and other objects, features, and advantages will become more readily apparent from the following description, reference being made to the accompanying drawing wherein:

FIG. 1 is a partly diagrammatic section through the sensor according to the invention; and

FIG. 2 is a section taken along line II-II of FIG. 1.

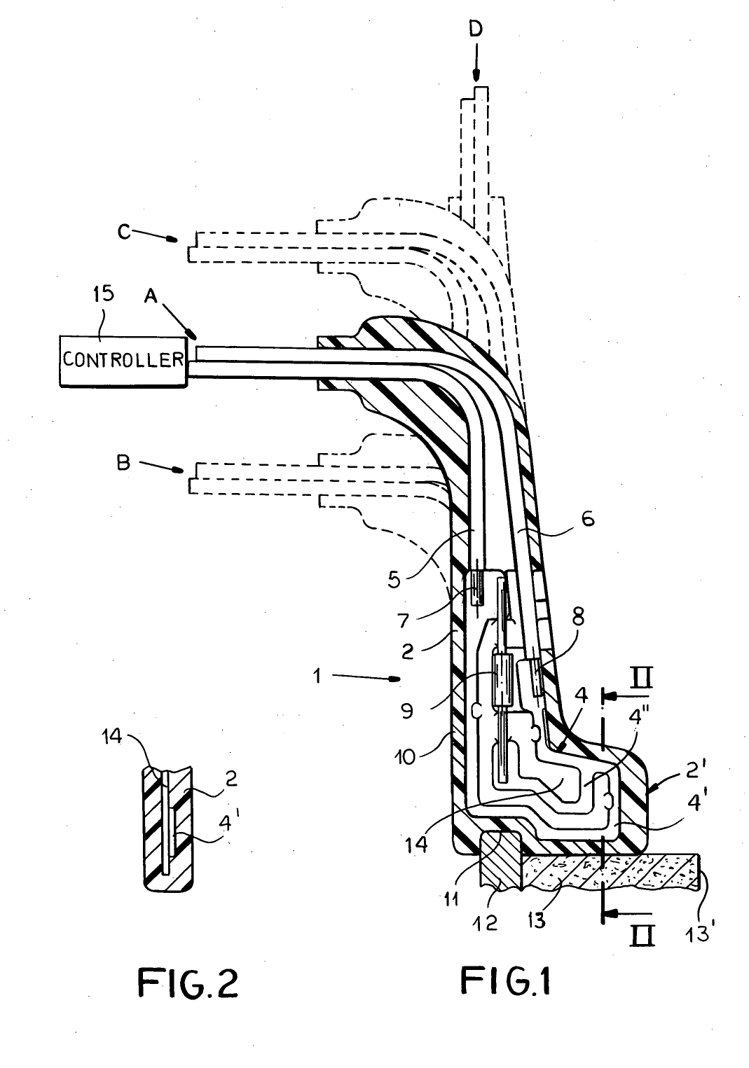

### SPECIFIC DESCRIPTION

As seen in the drawing a wear sensor 1 has a one-piece molded plastic housing 2 that is formed with an outer end 10 having an edge notch 11 fitted to a metal backing plate 12 carrying a composition brake pad 13 forming with the plate 12 a disk-brake shoe. The housing 2 has an outer surface 2′ facing away from the backing plate 12 and spaced inward from an outer face 13′ of the pad 13. As the pad 13 wears down, the housing 2 is worn away starting at this outer surface 2′.

As partly shown in FIG. 2 also, imbedded and wholly encapsulated by the one-piece housing 2 is a printed-circuit board 14 carrying a copper trace 4 having a low-impedance outer loop 4′ and a higher-impedance inner loop 4″. The outer loop 4′ has a leg closely juxtaposed with and spaced immediately outward of the surface 2′ and the inner loop 4″ has a leg parallel thereto but spaced more therefrom. Ends of the trace 4 are connected to stripped ends 7 and 8 of wires 5 and 6 that are imbedded in the housing 2 and that extend outward from the rear portion 3 thereof to a controller 15 that can be remotely located and that includes an acoustic or visible wear-indicating alarm. The inner loop 4″ is interrupted and the interruption is bridged by a resistor 9, giving it a higher resistance than the outer loop 4′ which is a dead short.

With this system, as the pad 13 wears down, the outer face 2′ of the housing 2 will be worn off. This will not affect the imbedded outer loop 4′. After some more wear, however, the outer trace 4′ will be worn off. Since it constitutes a direct short across the resistor 9, this wearing-away will increase the resistance between the conductors 5 and 6 basically to that of the resistor 9, giving the user a preliminary warning of brake-shoe wear. As the wear continues, the second loop 4″ will be worn away, creating an open circuit between the wires 5 and 6 to give the vehicle operator a more urgent warning of brake-shoe wear.

The sensor 1 according to the invention can easily be mounted on any type of brake shoe. Its rear end can be shortened as shown at B, lengthened as shown at C, or made to feed straight out as shown at D. Since all of the parts are totally encapsulated, including the ends of the wires 5 and 6, the entire assembly is insensitive to environmental conditions. No matter what the shape of the rear end 3, it forms a strain relief for the wires 5 and 6. Admittedly as the housing 2 wears away the trace 4 will be exposed, but over such a small area that, for example, any salty water bridging two exposed but spaced parts of the copper trace 4 will not have anything like the low resistance of the actual trace 4 or even of the resistor 9.

We claim:

1. A brake-shoe wear sensor comprising:
means including a sensor element capable of being worn away for generating different electrical outputs in accordance with wear;
at least one electrical wire connected to and extending outwardly away from the sensor element, whereby a controller can be connected to the sensor element via the wire; and
a one-piece housing having an inner end molded unitarily around and encapsulating the sensor element and an outer end spaced therefrom and molded unitarily around and encapsulating an outer end portion of the wire.

2. The brake-shoe wear sensor defined in claim 1 wherein the sensor element is a conductive metallic trace.

3. The brake-shoe wear sensor defined in claim 2 wherein the trace has a low-impedance loop and a separate high-impedance loop.

4. The brake-shoe wear sensor defined in claim 3 wherein one of the loops is spaced more closely to an outer face of the housing outer end than the other of the loops.

5. The brake-shoe wear sensor defined in claim 3 wherein the high-impedance loop includes a resistor.

6. The brake-shoe wear sensor defined in claim 1, further comprising
a second such wire connected to and extending outwardly away from the sensor element and encapsulated in the housing.

7. The brake-shoe wear sensor defined in claim 1 wherein the housing has a formation adapted to fit complementarily with a brake shoe.

8. A brake-shoe wear sensor comprising:
a conductive trace capable of being worn away for generating different electrical outputs in accordance with wear;
a pair of electrical wires connected to ends of the trace and extending outwardly away from the trace, whereby a controller can be connected to the sensor element via the wires; and
a one-piece housing having an inner end molded unitarily around and encapsulating the sensor element and an outer end spaced therefrom and molded unitarily around and encapsulating outer end portions of the wire.
